(19) United States
(12) Patent Application Publication
(10) Pub. No.: US 2011/0299559 A1
(43) Pub. Date: Dec. 8, 2011

(54) OPTICAL DEVICE

(75) Inventor: Nobuaki Mitamura, Kawasaki (JP)

(73) Assignee: FUJITSU OPTICAL COMPONENTS LIMITED, Kawasaki (JP)

(21) Appl. No.: 13/036,474

(22) Filed: Feb. 28, 2011

(30) Foreign Application Priority Data
Jun. 8, 2010 (JP) 2010-131211

(51) Int. Cl. H01S 3/04

(52) U.S. Cl. 372/34

(57) ABSTRACT

When environmental temperature becomes low, the quantity of light of the backward output light irradiated onto a light absorber formed on a mount over which a chip is mounted, is increased by a light quantity adjuster, to increase the optical absorption by the light absorber, thereby raising its temperature. As a result, the temperature of the chip on the mount rises, thereby enabling to substantially narrow a temperature range on a low temperature side. Accordingly, an optical device with low power consumption that can satisfy characteristics required for signal transmission at a required rate over a wide temperature range can be provided.

### CROSS-REFERENCE TO RELATED APPLICATION

This application is based upon and claims the benefit of priority of the prior Japanese Patent Application No. 2010-131211, filed on Jun. 8, 2010, the entire contents of which are incorporated herein by reference.

### FIELD

The embodiments discussed herein are related to an optical device equipped in various types of optical transmission devices used for optical communication.

### BACKGROUND

Recently, in optical transmission devices, a 10 Gb/s optical transceiver such as an XFP (10 Gigabit Small Form-factor Pluggable) has been widely used in the market. Such an optical transmission device may be installed in a building without air conditioning or outdoors, in a cold region such as near the polar zone or in a tropical region near the equator. In this case, guarantee of operation in a temperature range as wide as, for example, −40° C. to 85° C. may be required.

One of the important issues in realizing such an expansion of the operating temperature range is to satisfy the required characteristics for a semiconductor laser mounted over the optical transceiver. In a cooled semiconductor laser whose temperature is maintained constant on a thermo-electric cooler (TEC), which is also referred to as a thermoelectric cooling element or a Peltier element, such as an electro-absorption modulated laser (EML), the semiconductor laser is controlled to a required temperature regardless of the environmental temperature. Therefore, there is a low possibility that expansion of the operating temperature range becomes an issue. On the other hand, in an uncooled semiconductor laser without a TEC such as a direct modulated laser (DML), it is extremely difficult to satisfy the characteristics (for example, modulation characteristics) required for signal transmission at a required rate such as 10 Gb/s, over a wide temperature range, and hence, expansion of the operating temperature range becomes an issue.

As a conventional technique dealing with the above issues, for example, a configuration has been known where a heater is provided inside a mount of a semiconductor laser or outside a semiconductor laser module, and the semiconductor laser is heated by the heater only at the time of low temperature, by using a temperature sensor such as a thermistor (for example, refer to U.S. Pat. No. 7,492,798, and Japanese Laid-Open Patent Publication Nos. 2001-94200 and 2005-72197).

According to such a conventional technique, for example, the temperature range on the low temperature side can be substantially narrowed such as from −20° C. to 90° C., and the required characteristics such as modulation characteristic can be satisfied. Actually, a 10 Gb/s-DML ensuring an operating temperature of from −20° C. to 90° C. has been available in the market.

However, according to the above-described conventional technique, because the optical device is heated by using a heater, there is another problem in that the power consumption of a module using the optical device increases, and in practice this cannot be solved.

### SUMMARY

According to one aspect of the optical device of the invention, the optical device includes: a chip adapted to output laser beams forward and backward; a mount having the chip mounted thereover; a light absorber formed on the mount to absorb backward output light from the chip, to thereby raise its temperature; and a light quantity adjuster arranged in an area where the backward output light from the chip propagates, to increase the quantity of light of the backward output light irradiated onto the light absorber, when the environmental temperature changes to a low temperature side within an operating temperature range.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a sectional view illustrating a configuration of a general semiconductor laser.

FIG. 2 is a sectional view illustrating the configuration of a semiconductor laser according to a first embodiment (at the time of room temperature).

FIG. 3 is a sectional view illustrating the configuration of the semiconductor laser according to the first embodiment (at the time of low temperature).

FIG. 4 is a sectional view illustrating the configuration of the semiconductor laser according to the first embodiment (at the time of high temperature).

FIG. 5 is a sectional view illustrating a configuration of an application example of the first embodiment (at the time of room temperature).

FIG. 6 is a sectional view illustrating the configuration of the application example of the first embodiment (at the time of low temperature).

FIG. 7 is a sectional view illustrating the configuration of the application example of the first embodiment (at the time of high temperature).

FIG. 8 is a sectional view illustrating a configuration of a semiconductor laser according to a second embodiment (at the time of room temperature).

FIG. 9 is a sectional view illustrating the configuration of the semiconductor laser according to the second embodiment (at the time of low temperature).

FIG. 10 is a sectional view illustrating the configuration of the semiconductor laser according to the second embodiment (at the time of high temperature).

FIG. 11 is a sectional view illustrating a configuration of a semiconductor laser according to a third embodiment (at the time of room temperature).

FIG. 12 is a sectional view illustrating the configuration of the semiconductor laser according to the third embodiment (at the time of low temperature).

FIG. 13 is a sectional view illustrating the configuration of the semiconductor laser according to the third embodiment (at the time of high temperature).

FIG. 14 is a sectional view illustrating a configuration of an application example of the third embodiment.

FIG. 15 is a sectional view illustrating a configuration of a semiconductor laser according to a fourth embodiment.

FIG. 16 illustrates a transmittance-wavelength characteristic of a short-wavelength transmission filter used in the fourth embodiment.

FIG. 17 is a sectional view illustrating a configuration of a semiconductor laser according to a fifth embodiment.

FIG. 18 illustrates a transmittance-wavelength characteristic of a short-wavelength transmission filter used in the fifth embodiment.

### DESCRIPTION OF EMBODIMENTS

Hereunder, embodiments of the present invention are described in detail, with reference to the accompanying drawings.

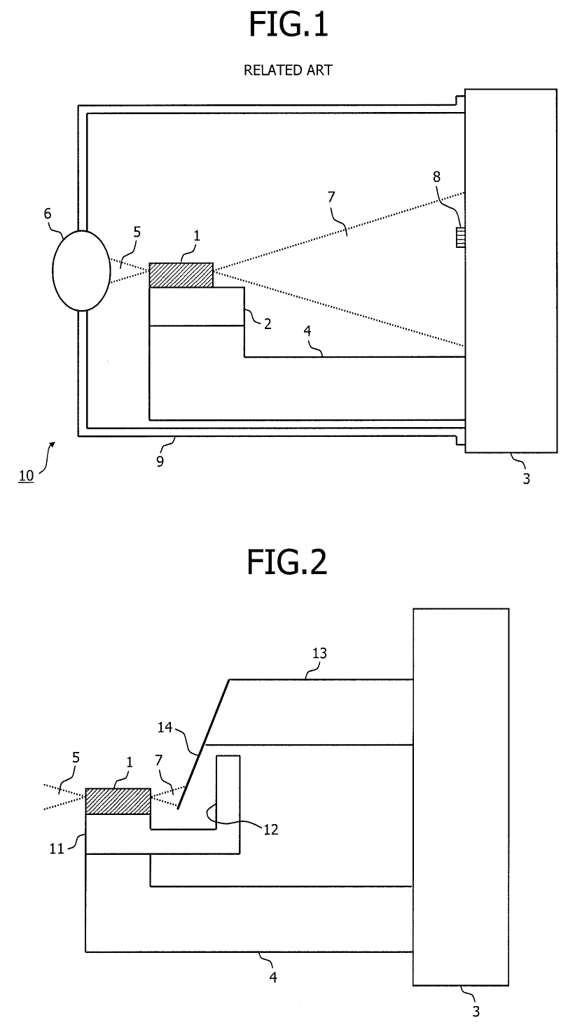

At first, because it is considered to be useful for understanding one aspect of the invention, a configuration of a general semiconductor laser is described with reference to the sectional view in FIG. 1.

In FIG. 1, a semiconductor laser chip 1 is fixed in a normal manner on a mount 2 by soldering for fixation of the chip or for wiring. Here the semiconductor laser chip 1 is a distributed feed-back (DFB) laser chip having a phase shift in a diffraction grating, and an antireflection coating is formed on both end faces. Moreover the semiconductor laser chip 1 is a direct modulated laser (DML) having a wavelength in the 1.3 μm band, and is used for 10 Gb/s transmission over a transmission distance of about 2 km. Because the semiconductor laser chip 1 is an uncooled type, it does not include a thermo-electric cooler (TEC). The mount 2 is fixed to a tip end portion of a post 4 arranged in an upright condition on a cylindrical stem 3.

Forward output light 5 emitted from the front of the semiconductor laser chip 1 is collected by a lens 6 and focused on an optical fiber (not illustrated in the drawing). In a transmitter optical sub assembly (TOSA) mounted over a pluggable optical transceiver such as an XFP, forward output light 5 is collected by an optical fiber stub of a receptacle. In the case of a phase shift DFB laser, because the antireflection coating is formed on both end faces of the chip, light having substantially the same intensity as that of the forward output light is emitted from the back of the semiconductor laser chip 1, which is referred to as backward output light 7.

When control for maintaining constant intensity of the forward output light 5 (auto power control (APC)) is to be performed, the backward output light 7 is used for monitoring the intensity of the forward output light 5 without causing a loss on the forward output light 5. Here a monitor photodetector (PD) 8 is arranged within a range of coverage of the backward output light 7 on the stem 3, and the relative intensity of the backward output light 7 is monitored by the monitor PD 8 to perform APC based on the monitoring result thereof. The backward output light 7 is not normally used in applications other than the above.

Moreover because the semiconductor laser chip 1 is deteriorated due to humidity, the periphery of a cap 9 fitted with the lens 6 is resistance-welded on the stem 3, and the interior is hermetically sealed with dry nitrogen or the like. The semiconductor laser configured in this manner is referred to as a laser CAN 10, and is used for optical transceivers such as TOSA or bi-directional (BIDI).

In the above general uncooled semiconductor laser, it is difficult to realize guarantee of operation over a wide temperature range of from −40° C. to 85° C., and even if the semiconductor laser is heated at the time of low temperature by using a heater to substantially narrow the temperature range on the low temperature side, an increase in power consumption becomes a problem. Therefore in one aspect of the invention, the backward output light is used for heating the semiconductor laser to thereby solve the above problem. Hereunder embodiments of the semiconductor laser, which is one of the optical devices according to the invention, are described in detail.

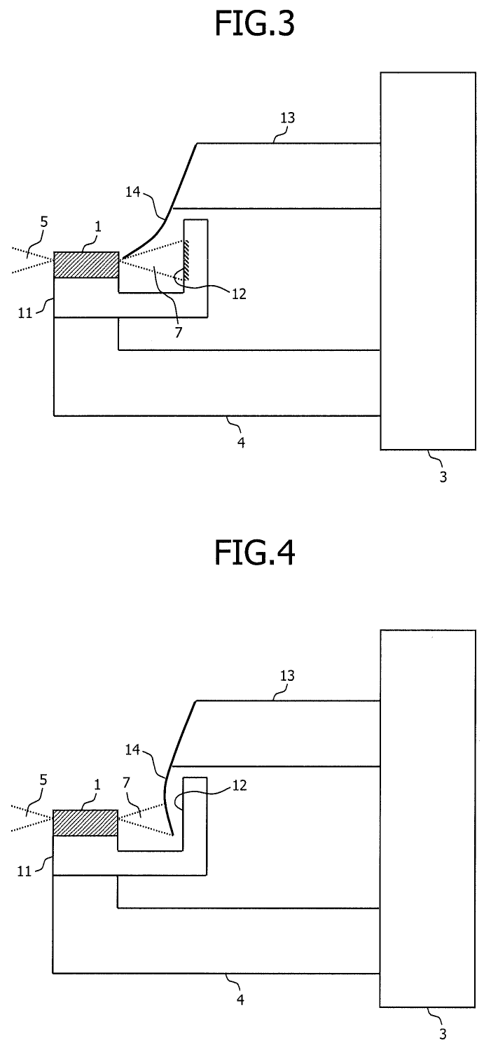

FIG. 2 to FIG. 4 are sectional views illustrating a configuration of a semiconductor laser according to a first embodiment. FIG. 2 illustrates a state in which the environmental temperature is room temperature (for example, 25° C.), FIG. 3 illustrates a state in which the environmental temperature is low (for example, −40° C.), and FIG. 4 illustrates a state in which the environmental temperature is high (for example, 85° C.). In FIG. 2 to FIG. 4, parts the same as in the configuration illustrated in FIG. 1 are denoted by the same reference symbols, and similarly hereunder in other figures.

In FIG. 2 to FIG. 4, the semiconductor laser according to the first embodiment includes, for example, a semiconductor laser chip 1, a mount 11 to which the semiconductor laser chip is fixed, a light absorber 12 formed on the mount 11, a stem 3, a post 4 arranged in an upright condition on the stem 3 with the mount 11 fixed to a tip end portion thereof, a post 13 arranged in an upright condition on the stem 3 at a position different from the post 4, and a bimetallic shield 14 fixed at a tip end portion of the post 13.

In FIG. 2 to FIG. 4, to facilitate understanding of the sectional structure of the first embodiment, the cap 9 fitted with the lens 6 in the general semiconductor laser illustrated in FIG. 1 is omitted. That is, even in the first embodiment, the semiconductor laser can be used as the laser CAN by resistance-welding the periphery of the cap fitted with the lens on the stem as in FIG. 1. Hereinafter, the illustration of cap fitted with the lens is also omitted in the description of other embodiments.

The semiconductor laser chip 1, the stem 3, and the post 4 are the same as those illustrated in FIG. 1, which are used in the general semiconductor laser. On the other hand, the mount 11 to which the semiconductor laser chip 1 is fixed is different from the mount 2 illustrated in FIG. 1. The mount 11 is formed of a material having a high thermal conductivity such as aluminum nitride (AlN), and has a light absorber 12 at a position in a substantially U-shaped cross-section where the backward output light 7 is irradiated from the semiconductor laser chip 1. The light absorber 12 is constituted by applying an infrared absorbing material that efficiently absorbs near-infrared light in the 1.3 μm band, to the surface of the irradiation position on the mount 11, or by bonding a thin plate made of an infrared absorbing material to the irradiation position on the mount 1.

As the infrared absorbing material used for the light absorber 12, for example, well-known various materials disclosed in Japanese Patent No. 4196019 can be used. Specifically, single crystals of a compound semiconductor such as GaAs, GaAsP, GaAlAs, InP, InSb, InAs, PbTe, InGaAsP and ZnSe; materials in which particles of the compound semiconductor are dispersed in a matrix material; single crystals of metal halides (for example, potassium bromide and sodium chloride) doped with dissimilar metal ions; materials in which particles of the metal halides (for example, copper bromide, copper chloride, and cobalt chloride) are dispersed in a matrix material; single crystals of cadmium chalcogenide such as CdS, CdSe, CdSeS, and CdSeTe doped with dissimilar metal ions such as copper; materials in which particles of the cadmium chalcogenide are dispersed in a matrix material; a semiconductor single crystal thin film, a polycrystalline thin film, and a porous thin film such as silicon, germanium, selenium, and tellurium; materials in which semiconductor particles such as silicon, germanium, selenium, and tellurium are dispersed in a matrix material; single crystals corresponding to gems doped with metal ions such as ruby, alexandrite, garnet, Nd:YAG, sapphire, Ti:sapphire, and Nd:YLF (a so-called, laser crystal); ferroelectric crystals such as lithium niobate (LiNbO₃), LiB₃O₅, LiTaO₃, KTiOPO₄, KH₂PO₄, KNbO₃, and BaB₂O₂ doped with metal ions (for example, iron ions); and silica glass, soda glass, borosilicate glass, and other glasses doped with metal ions (for example, neodymium ions and erbium ions) can be used for the infrared absorbing material. Moreover, other than the above-described materials, materials in which a dye is dissolved or dispersed in a matrix material can be used for the infrared absorbing material (as the dye, xanthene dyes such as rhodamine B, rhodamine 6G, eosin, and phloxin B, acridine dyes such as acridine orange and acridine red, azo dyes such as ethyl red and methyl red, porphyrin dye, phthalocyanine dye, cyanine dyes such as 3,3′-diethylthiacarbocyanine iodide and 3,3′-diethyloxadicarbocyanine iodide, and triarylmethane dyes such as ethyl violet and victoria blue R can be mentioned).

Alternatively, as other specific examples of the infrared absorbing material to be used for the light absorber 12, carbon black, graphite, cyanine dye, squarylium dye, methine dye, naphthoquinone dye, quinoneimine dye, quinonediimine dye, naphthalocyanine dye, dithiol-metal complex dye, anthraquinone dye, tris-azo dye, pyrylium salt dye, aminium salt dye and the like as disclosed in Japanese Laid-Open Patent Publication No. 5-24374 can be used. Moreover, oxides, sulfides, halides containing Nd, Yb, In, Sn, and Zn, or compounds thereof as disclosed in Japanese Laid-Open Patent Publication No. 7-113072 can be used.

The semiconductor laser according to the first embodiment, in addition to the mount 11 including the light absorber 12, has a bimetallic shield 14 fixed soldering or the like to the post 13 arranged in an upright condition on the stem 3, between the semiconductor laser chip 1 and the light absorber 12 of the mount 11. The bimetallic shield 14 is formed of a composite metal plate (bimetal) obtained by laminating two types of metal plates having different coefficients of thermal expansion together, and an amount of curvature thereof changes according to the temperature.

Specifically, the bimetallic shield 14 is substantially straight in the room-temperature state illustrated in FIG. 2 in which the environmental temperature is about 25° C., and the characteristics, arrangement, and the like of the bimetallic shield 14 are designed so that the backward output light 7 from the semiconductor laser chip 1 is shielded by the tip end portion of the bimetallic shield 14 protruding from the post 13, and is not irradiated onto the light absorber 12 of the mount 11. In the room-temperature state, the light absorber 12 does not generate heat.

On the other hand, in the low-temperature state illustrated in FIG. 3, in which the environmental temperature is about −40° C., the bimetallic shield 14 has a curved shape toward the semiconductor laser chip 1, and the characteristics, arrangement, and the like of the bimetallic shield 14 are designed so that the backward output light 7 from the semiconductor laser chip 1 is irradiated onto the light absorber 12 of the mount 11, without being shielded by the tip end portion of the bimetallic shield 14. In this low-temperature state, because the light absorber 12 absorbs the backward output light 7, the optical energy is converted into thermal energy and the light absorber 12 generates heat to raise its temperature. When the temperature of the light absorber 12 rises, the temperature of the entire mount 11 and the semiconductor laser chip 1 fixed to the mount 11 also rises. It was confirmed by actual temperature measurement that when the environmental temperature was −40° C., the temperature of the semiconductor laser chip 1 became equal to or higher than −20° C., which was higher than the environmental temperature by 20° C. or more.

Preferably a material such as glass having a low thermal conductivity is used for the material of the post 4 to which the mount 11 is fixed, so that the generated heat of the mount 11 does not escape. As a result, the temperature of the semiconductor laser chip 1 can be efficiently raised by using the backward output light 7.

Moreover in the high-temperature state illustrated in FIG. 4, in which the environmental temperature is about 85° C., the bimetallic shield 14 has a curved shape toward the light absorber 12 of the mount 11, and the characteristics, arrangement, and the like of the bimetallic shield 14 are designed so that the backward output light 7 from the semiconductor laser chip 1 is shielded by the tip end portion of the bimetallic shield 14 and is not irradiated onto the light absorber 12 of the mount 11, similarly to the aforementioned case in which the environmental temperature is room temperature. Also in the high-temperature state, the light absorber 12 does not generate heat.

In the room-temperature and high-temperature states, if the backward output light 7 from the semiconductor laser chip 1 is reflected by the bimetallic shield 14, and the reflected light returns to the semiconductor laser chip 1, noise increases, which is not desired. Therefore, in the configuration example illustrated in FIG. 2 to FIG. 4, a shielding surface of the bimetallic shield 14 is arranged with an inclination with respect to an outgoing direction of the backward output light 7. Moreover, instead of arranging the bimetallic shield 14 with an inclination, the surface of the bimetallic shield 14 can be roughened so that the backward output light 7 is diffuse reflected, or the surface of the bimetallic shield 14 can be subjected to anti-reflection processing, such as applying an anti-reflection coating.

As described above, according to the semiconductor laser of the first embodiment, the quantity of light of the backward output light 7 irradiated from the semiconductor laser chip 1 onto the light absorber 12 of the mount 11 automatically increases at the time of low temperature, due to the bimetallic shield 14 which changes its amount of curvature according to a change in the environmental temperature, to change the amount of light to be shielded, and the optical absorption by the light absorber 12 of the mount 11 increases to raise its temperature. As a result, the temperature of the semiconductor laser chip 1 mounted over the mount 11 rises, thereby enabling to substantially narrow the temperature range on the low temperature side. Accordingly, the characteristics required for signal transmission at the required rate can be satisfied over a wide temperature range. Because the semiconductor laser does not require heating by a heater, there is also no increase in power consumption.

Next an application example of the semiconductor laser according to the first embodiment will be described. In the application example, a configuration capable of supporting APC of the semiconductor laser is considered.

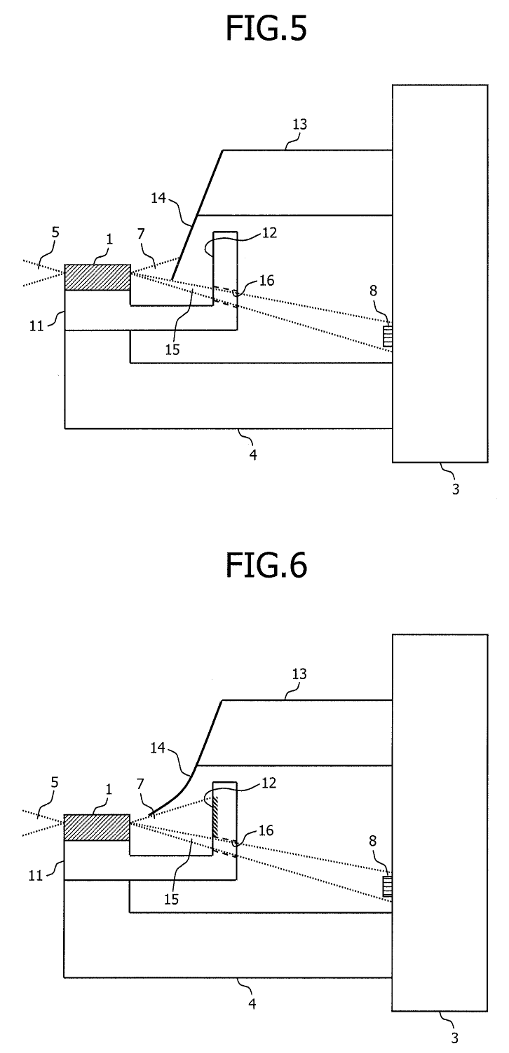

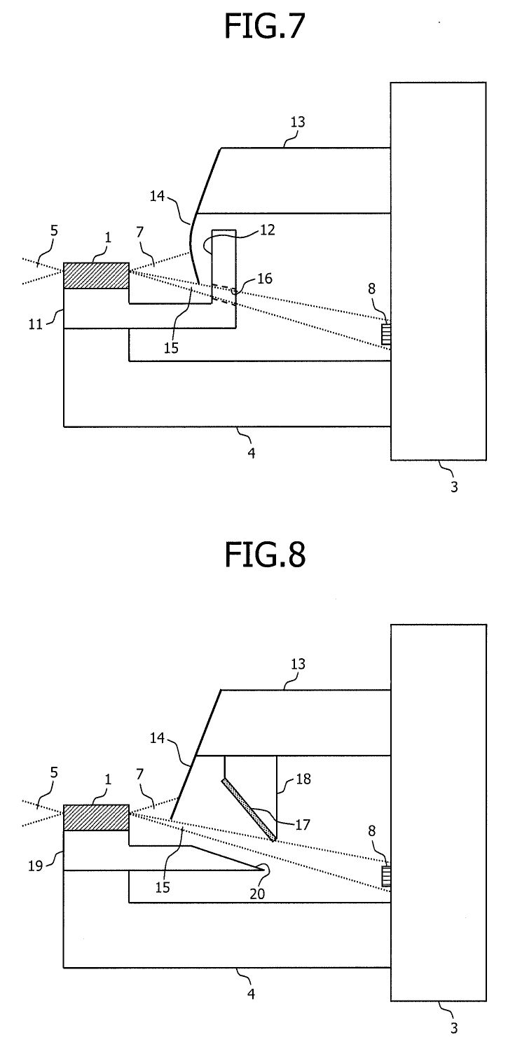

FIG. 5 to FIG. 7 are sectional views illustrating a configuration of the application example of the semiconductor laser. FIG. 5 illustrates a state in which the environmental temperature is room temperature, FIG. 6 illustrates a state in which the environmental temperature is low, and FIG. 7 illustrates a state in which the environmental temperature is high.

In the application example illustrated in FIG. 5 to FIG. 7, in order to perform APC for maintaining constant intensity of the forward output light 5 output from the semiconductor laser to the outside, at first an unshielded area 15 of the backward output light 7 is set so that the backward output light 7 from the semiconductor laser chip 1 is not shielded by the bimetallic shield 14 in any environmental temperature range, without depending on the deformation (curvature) of the bimetallic shield 14 due to the change in the environmental temperature. Then a hole 16 is formed in a portion overlapping on the unshielded area 15 of the mount 11, and a monitor PD 8 is provided within a range where the backward output light 7 having passed through the hole 16 reaches the stem 3. As a result, as illustrated in FIG. 5 to FIG. 7, even when the environmental temperature changes in a range of about −40° C. to 85° C., a part of the backward output light 7 having passed through the hole 16 in the mount 11 is received by the monitor PD 8, and the relative intensity of the backward output light 7 is monitored. The intensity of the forward output light 5 output from the semiconductor laser to the outside is determined based on the monitoring result obtained by the monitor PD 8, and the drive status of the semiconductor laser chip 1 is controlled so as to maintain the constant intensity, thereby enabling to perform APC without causing a loss in the forward output light 5, in addition to effects similar to those of the first embodiment.

Next is a description of a second embodiment of a semiconductor laser.

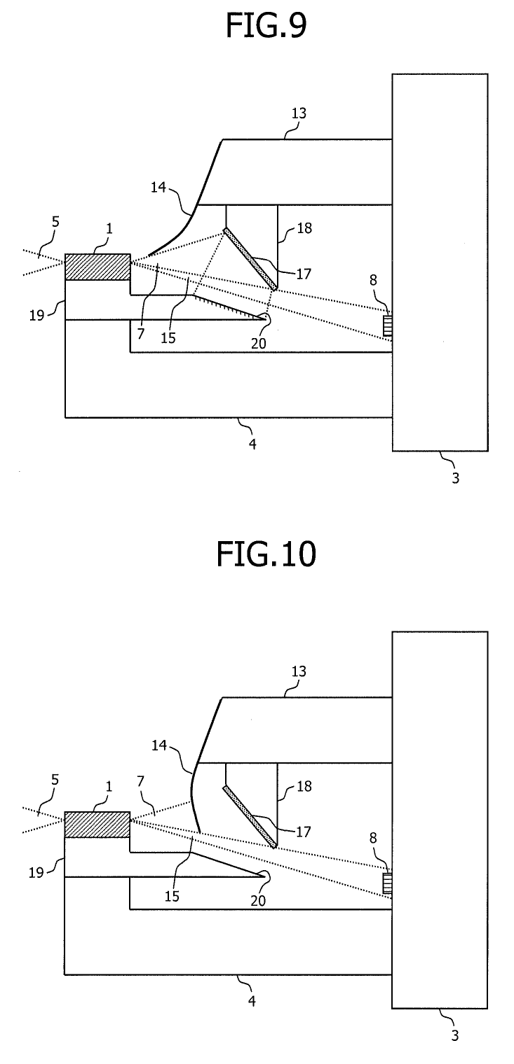

FIG. 8 to FIG. 10 are sectional views illustrating a configuration of the semiconductor laser according to the second embodiment. FIG. 8 illustrates a state in which the environmental temperature is room temperature (for example, 25° C.), FIG. 9 illustrates a state in which the environmental temperature is low (for example, −40° C.), and FIG. 10 illustrates a state in which the environmental temperature is high (for example, 85° C.).

In FIG. 8 to FIG. 10, the semiconductor laser according to the second embodiment includes for example, a reflecting mirror 17 that reflects backward output light 7 from a semiconductor laser chip 1, and a fixing member 18 that fixes the reflecting mirror 17 to a post 13, in addition to the configuration of the application example of the first embodiment illustrated in FIG. 5 to FIG. 7, and also uses a mount 19 having a different shape. The semiconductor laser chip 1, a bimetallic shield 14, a monitor PD 8, a stem 3, and posts 4 and 13 are the same as those in the application example of the first embodiment.

The reflecting mirror 17 is fixed to the post 13 via the fixing member 18 so that a major part of the backward output light 7 is reflected when backward output light 7 from the semiconductor laser chip 1 is not shielded by the bimetallic shield 14 in the low-temperature state, and the reflected light is irradiated onto a light absorber 20 of the mount 19.

The mount 19 is designed in such a shape that an unshielded area 15 of the backward output light 7 is set so that the backward output light 7 from the semiconductor laser chip 1 is not shielded by the bimetallic shield 14 in any environmental temperature range, without depending on the deformation (curvature) of the bimetallic shield 14 due to the change in the environmental temperature, and the mount 19 does not overlap on the unshielded area 15. The mount 19 has a substantially L-shaped cross-section, and includes a light absorber 20 on a tip end surface cut at an angle and facing the reflecting mirror 17. The light absorber 20 is similar to the light absorber 12 in the first embodiment, and is constituted by applying an infrared absorbing material to the tip end surface of the mount 19 or by bonding a thin plate made of an infrared absorbing material to the tip end surface of the mount 19.

In the semiconductor laser having the above-described configuration, the bimetallic shield 14 is substantially straight in the state illustrated in FIG. 8 in which the environmental temperature is room temperature, and components of the backward output light 7 from the semiconductor laser chip 1 traveling toward the reflecting mirror 17 are shielded by the tip end portion of the bimetallic shield 14 protruding from the post 13. As a result, because there is no backward output light 7 reflected by the reflecting mirror 17 and irradiated onto the light absorber 20 of the mount 19, the light absorber 20 does not generate heat in the room-temperature state.

On the other hand, in the state illustrated in FIG. 9 in which the environmental temperature is low, the bimetallic shield 14 has a curved shape toward the semiconductor laser chip 1, and components of the backward output light 7 from the semiconductor laser chip 1 traveling toward the reflecting mirror 17 reach the reflecting mirror 17 and are reflected without being shielded by the tip end portion of the bimetallic shield 14, and are irradiated onto the light absorber 20 of the mount 19. In this low-temperature state, because the light absorber 20 absorbs the backward output light 7, the optical energy is converted into thermal energy and the light absorber 20 generates heat to raise its temperature. When the temperature of the light absorber 20 rises, the temperature of the entire mount 19 and the semiconductor laser chip 1 fixed on the mount 19 also rises. Also in the semiconductor laser according to the second embodiment, it was confirmed by actual temperature measurement that when the environmental temperature was −40° C., the temperature of the semiconductor laser chip 1 became equal to or higher than −20° C., as in the first embodiment.

Moreover in the state illustrated in FIG. 10 in which the environmental temperature is high, the bimetallic shield 14 has a curved shape toward the reflecting mirror 17, and components of the backward output light 7 from the semiconductor laser chip 1 traveling toward the reflecting mirror 17 are shielded by the tip end portion of the bimetallic shield 14, and do not reach the reflecting mirror 17, as in the aforementioned case in which the environmental temperature is room temperature. Therefore, even in the high-temperature state, the light absorber 20 does not generate heat.

As illustrated in FIG. 8 to FIG. 10, components of the backward output light 7 from the semiconductor laser chip 1 traveling toward the monitor PD 8 pass through between the reflecting mirror 17 and the tip end surface of the mount 19 and are received by the monitor PD 8, without being shielded by the bimetallic shield 14 even if the environmental temperature changes, and the relative intensity of the components is monitored by the monitor PD 8.

Also according to the semiconductor laser of the second embodiment, similar to the aforementioned result of the first embodiment, the quantity of light of the backward output light 7 irradiated from the semiconductor laser chip 1 onto the light absorber 20 of the mount 19 via the reflecting mirror 17 automatically increases at the time of low temperature, due to the bimetallic shield 14 which changes its amount of curvature according to a change in the environmental temperature, to change the amount of light to be shielded, and the optical absorption by the light absorber 20 of the mount 19 increases to raise its temperature. As a result, the temperature of the semiconductor laser chip 1 mounted over the mount 19 rises, thereby enabling to substantially narrow the temperature range on the low temperature side. Accordingly, the characteristics required for signal transmission at the required rate can be satisfied over a wide temperature range. Because the semiconductor laser does not require heating by a heater, there is also no increase in power consumption. Moreover, by using the reflecting mirror 17, the hole 16 corresponding to the unshielded area 15 as illustrated in FIG. 5 to FIG. 7 is not required in order to monitor the relative intensity of the backward output light 7 by the monitor PD 8, and hence the mount 19 can be easily processed.

Next is a description of a third embodiment of a semiconductor laser.

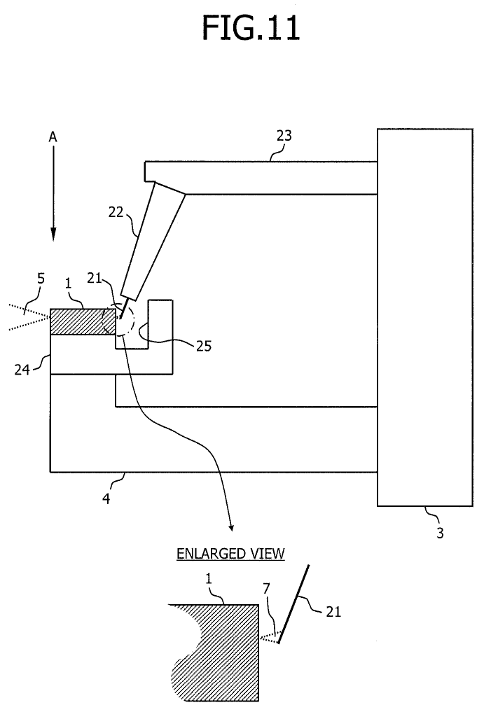

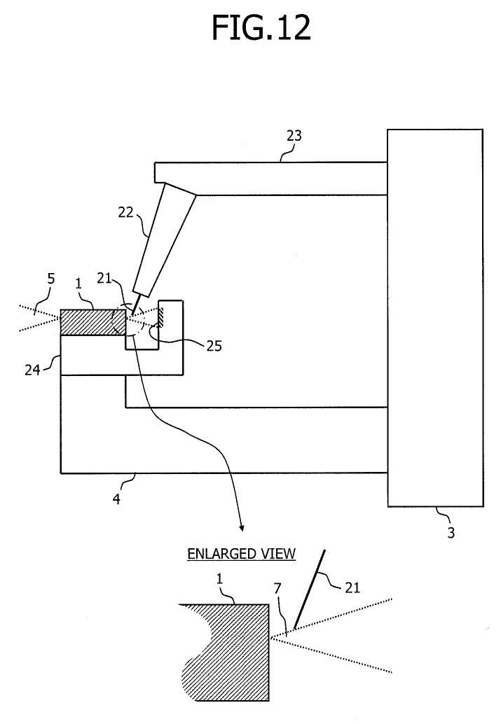

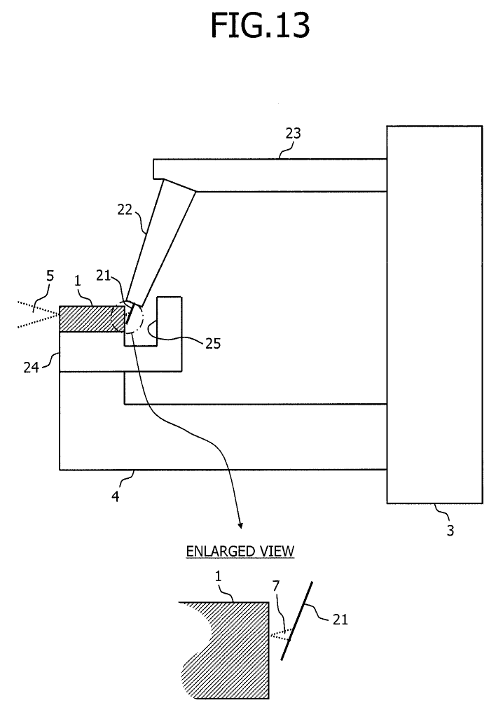

FIG. 11 to FIG. 13 are sectional views illustrating a configuration of the semiconductor laser according to the third embodiment. FIG. 11 illustrates a state in which the environmental temperature is room temperature (for example, 25° C.), FIG. 12 illustrates a state in which the environmental temperature is low (for example, −40° C.), and FIG. 13 illustrates a state in which the environmental temperature is high (for example, 85° C.).

In FIG. 11 to FIG. 13, in the semiconductor laser of the third embodiment, for example, instead of the bimetallic shield 14 and the post 13 for fixing the bimetallic shield 14 in the configuration of the semiconductor laser of the first embodiment illustrated in FIG. 2 to FIG. 4, a shield 21, a fixing member 22 to which the shield 21 is fixed, and a post 23 arranged in an upright condition on a stem 3, with the fixing member 22 being fixed to the end portion thereof, are provided, and a substantially U-shaped cross-section of a mount 24 to which the semiconductor laser chip 1 is fixed, is made smaller than that of the first embodiment. The semiconductor laser chip 1, the stem 3, and the post 4 are the same as those of the first embodiment.

A position of the shield 21 with respect to backward output light 7 from the semiconductor laser chip 1 changes according to extension and contraction of the fixing member 22 due to a change in the environmental temperature. The fixing member 22 is formed of a material having a high rate of thermal expansion such as resin, and can extend and contract largely in a longitudinal direction in the cross-section illustrated in these figures due to a change in the environmental temperature. Here, one end of the fixing member 22 is fixed to a distal end portion of the post 23 arranged in an upright condition on a stem 3, and the shield 21 is fixed to the other end (free end) of the fixing member 22. Therefore, a relative position of the backward output light 7 and the shield 21 is changed by the extension and contraction of the fixing member 22 corresponding to a change in the environmental temperature, as illustrated in the enlarged views in FIG. 11 to FIG. 13.

A mount 24 to which the semiconductor laser chip 1 is fixed, is formed of a material having a high thermal conductivity such as aluminum nitride (AlN) as in the mount 11 used in the first embodiment, and has a light absorber 25 at a position in a substantially U-shaped cross-section where the backward output light 7 is irradiated from the semiconductor laser chip 1. A difference from the mount 11 in the first embodiment is that because displacement of the shield 21 due to a change in the environmental temperature is smaller as compared with deformation (curvature) of the bimetallic shield 14, the substantially U-shaped cross-section of the mount 24 is changed so that the light absorber 25 approaches the rear end of the semiconductor laser chip 1.

In the semiconductor laser having such a configuration, in the state illustrated in FIG. 11 in which the environmental temperature is room temperature, the tip end portion of the shield 21 fixed to the fixing member 22 shields the backward output light 7 from the semiconductor laser chip 1 (refer to the enlarged view). As a result, because the backward output light 7 is not irradiated onto the light absorber 25 of the mount 24, the light absorber 25 does not generate heat in the room-temperature state.

On the other hand, in the state illustrated in FIG. 12 in which the environmental temperature is low, because the fixing member 22 largely contracts, the shield 21 fixed to the fixing member 22 is at a position where the backward output light 7 from the semiconductor laser chip 1 is not shielded (refer to the enlarged view), and the backward output light 7 is irradiated onto the light absorber 25 of the mount 24. In this low-temperature state, because the light absorber 25 absorbs the backward output light 7, the optical energy is converted into thermal energy and the light absorber 25 generates heat to raise its temperature. When the temperature of the light absorber 25 rises, the temperature of the entire mount 24 and the semiconductor laser chip 1 fixed to the mount 24 also rises. Also in the semiconductor laser according to the third embodiment, it was confirmed by actual temperature measurement that when the environmental temperature was −40° C., the temperature of the semiconductor laser chip 1 became equal to or higher than −20° C., as in the first embodiment.

Moreover in the state illustrated in FIG. 13 in which the environmental temperature is high, the fixing member 22 largely extends. However, the backward output light 7 from the semiconductor laser chip 1 is shielded by a part of the shield 21 slightly inward from the tip end thereof (refer to the enlarged view), and does not reach the light absorber 25 of the mount 24, as in the aforementioned case in which the environmental temperature is room temperature. Therefore, even in the high-temperature state, the light absorber 25 does not generate heat.

In the room-temperature and high-temperature states, so that the backward output light 7 shielded (reflected) by the shield 21 does not return to the semiconductor laser chip 1, then in the configuration example illustrated in FIG. 10 to FIG. 13, a shielding surface of the shield 21 is arranged with an inclination with respect to the outgoing direction of the backward output light 7. Moreover, instead of arranging the shield 21 with an inclination, the surface of the shield 21 can be roughened so that the backward output light 7 is diffuse reflected, or the surface of the shield 21 can be subjected to anti-reflection processing, such as applying an anti-reflection coating.

Also according to the semiconductor laser of the third embodiment, similar to the aforementioned result of the first embodiment, the quantity of light of the backward output light 7 irradiated from the semiconductor laser chip 1 onto the light absorber 25 of the mount 24 automatically increases at the time of low temperature, due to the shield 21 fixed to the fixing member 22 that extends and contracts according to a change in the environmental temperature, to thereby change the amount of light to be shielded, and the optical absorption by the light absorber 25 of the mount 24 increases. As a result, the temperature of the semiconductor laser chip 1 mounted over the mount 24 rises, thereby enabling to substantially narrow the temperature range on the low temperature side. Accordingly, the characteristics required for signal transmission at the required rate can be satisfied over a wide temperature range. Because the semiconductor laser does not require heating by a heater, there is also no increase in power consumption.

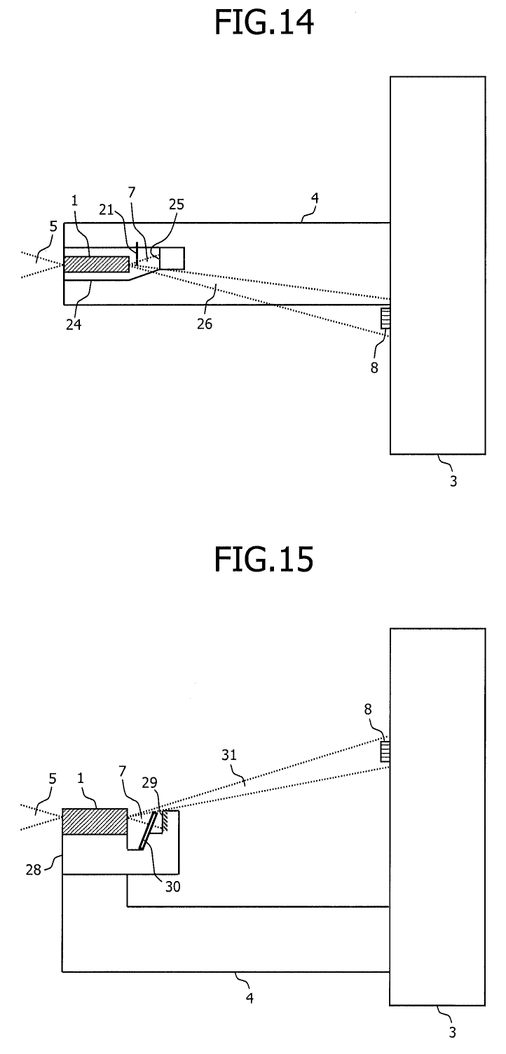

Also in the semiconductor laser of the third embodiment, as in the application example of the first embodiment, an application which adds a function for monitoring the relative intensity of the backward output light 7 is possible. FIG. 14 is a sectional view illustrating a configuration of an application example of the third embodiment in which a monitoring function of the backward output light is added. FIG. 14 illustrates a view of a section through the semiconductor laser chip 1 as seen from an orthogonal direction (the direction of arrow A in FIG. 11) in the sectional view in FIG. 11.

Specifically, in the application example illustrated in FIG. 14, the unshielded area 26 of the backward output light 7 is set to the side of the shield 21 such that the backward output light 7 from the semiconductor laser chip 1 is not shielded by the shield 21 in any environmental temperature without depending on the displacement of the shield 21 (movement in a direction substantially vertical to the sheet in FIG. 14) due to extension and contraction of the fixing member 22 (not illustrated in FIG. 14) corresponding to a change in the environmental temperature. Moreover the shape of the mount 24 is changed so as not to overlap on the unshielded area 26, and the monitor PD 8 is provided within a range in which the backward output light 7 having passed the side of the mount 24 reaches the stem 3. As a result, even if the environmental temperature is changed, a part of the backward output light 7 traveling in the unshielded area 26 is received by the monitor PD 8, and the relative intensity of the backward output light 7 is monitored. Based on the monitoring result obtained by the monitor PD 8, the intensity of the forward output light 5 output from the semiconductor laser to the outside is determined, and the drive status of the semiconductor laser chip 1 is controlled so as to maintain the constant intensity, thereby enabling to perform APC without causing a loss in the forward output light 5, in addition to the effects of the third embodiment.

Next is a description of a fourth embodiment of a semiconductor laser.

FIG. 15 is a sectional view illustrating a configuration of the semiconductor laser of the fourth embodiment.

In FIG. 15, the semiconductor laser according to the fourth embodiment uses a mount 28 in which the shape of the mount 11 is changed, and instead of the bimetallic shield 14 and the post 13 for fixing the bimetallic shield 14, in the configuration of the first embodiment illustrated in FIG. 2 to FIG. 4, a short-wavelength transmission filter 30 is provided on the mount 28. Furthermore the semiconductor laser includes a monitor PD 8 for monitoring the relative intensity of the backward output light 7 from a semiconductor laser chip 1, on a stem 3. The semiconductor laser chip 1, the stem 3, and the post 4 are the same as those of the first embodiment.

The mount 28 is formed of a material having a high thermal conductivity such as aluminum nitride (AlN), and includes a light absorber 29 at a position where the backward output light 7 from the semiconductor laser chip 1 is irradiated, passing through the short-wavelength transmission filter 30. The light absorber 29 is the same as the light absorber 12 in the first embodiment, and is constituted by applying an infrared absorbing material to the irradiation position on the mount 29 or by bonding a thin plate made of an infrared absorbing material to the irradiation position on the mount 28.

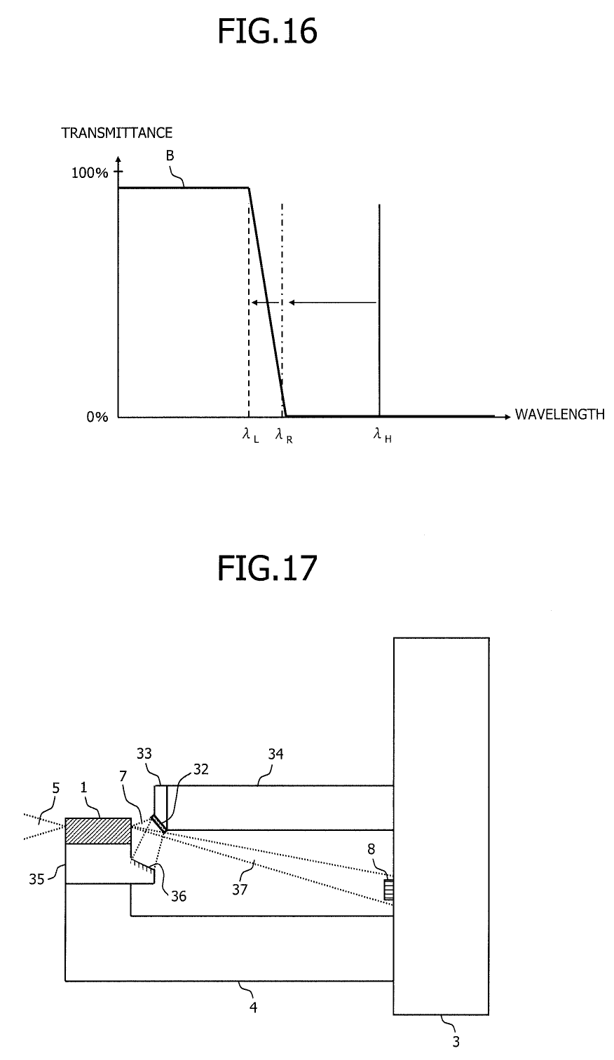

The short-wavelength transmission filter 30 here uses a step portion formed on the mount 28 and fixed to the step portion by an adhesive or the like, so as to be positioned between the semiconductor laser chip 1 and the light absorber 29 of the mount 28. The short-wavelength transmission filter 30 is formed of a dielectric multilayer film, and has a transmittance-wavelength characteristic B, for example, as illustrated in FIG. 16 (wavelength is plotted on the X axis and transmittance is plotted on the Y axis). Preferably a short-wavelength transmission filter having a wavelength temperature dependence equal to or less than 0.001 nm/° C. is used as the short-wavelength transmission filter 30, and a transmission filter having such a small wavelength temperature dependence is commercially available. With respect to the wavelength temperature dependence of the short-wavelength transmission filter 30, the wavelength temperature dependence of the semiconductor laser chip 1 is about 0.1 nm/° C., and hence, the semiconductor laser chip 1 has a large wavelength temperature dependence more than 100 times that of the short-wavelength transmission filter 30.

For example, when it is assumed that the oscillation wavelength of the semiconductor laser chip 1 at 85° C. is λ_{H}, the oscillation wavelength thereof at room temperature (25° C.) is λ_{R}, and the oscillation wavelength thereof at −20° C. is λ_{L} (λ_{L}<λ_{R}<λ_{H}), the transmittance-wavelength characteristic B of the short-wavelength transmission filter 30 is designed so that the relation illustrated in FIG. 16 is obtained with respect to the temperature dependence of the oscillation wavelength of the semiconductor laser chip 1, that is, a transmittance close to 100% can be obtained on the short wavelength side from the wavelength λ_{L} and the transmittance approaches 0% on the long wavelength side from near the wavelength λ_{R}. At this time, because the wavelength temperature dependence of the short-wavelength transmission filter 30 is sufficiently smaller than the wavelength temperature dependence of the semiconductor laser chip 1 as mentioned above, it can be ignored.

The monitor PD 8 is fixed within a range where a transit area 31 of the backward output light 7 reaches to on the stem 3. The transit area 31 of the backward output light 7 is set in an area in which the backward output light 7 from the semiconductor laser chip 1 travels toward the stem 3, passing above the short-wavelength transmission filter 30 and the mount 28 without being shielded by the short-wavelength transmission filter 30.

In the semiconductor laser having such a configuration, in a range of the environmental temperature of from 85° C. to room temperature, components of the backward output light 7 from the semiconductor laser chip 1 traveling toward the light absorber 29 cannot pass through the short-wavelength transmission filter 30, and almost all of the components are reflected by the short-wavelength transmission filter 30. Therefore, the backward output light 7 is not substantially irradiated onto the light absorber 29 of the mount 28, and the light absorber 29 does not generate heat.

On the other hand, in a range of the environmental temperature of from room temperature to −40° C., the amount of components of the backward output light 7 from the semiconductor laser chip 1 traveling toward the light absorber 29 and passing through the short-wavelength transmission filter 30 gradually increases, with a decrease in temperature from near the room temperature, and the amount of transmission of the backward output light 7 becomes largest near −40° C. Therefore, when the environmental temperature is as low as −40° C., the backward output light 7 is irradiated largely onto the light absorber 29 of the mount 28, and the light absorber 29 generates heat. Therefore, in the low-temperature state, as in the first embodiment, the temperature of the entire mount 28 and the semiconductor laser chip 1 on the mount 28 rises due to heat generation of the light absorber 29. Also in the fourth embodiment, it was confirmed by actual temperature measurement that when the environmental temperature was −40° C., the temperature of the semiconductor laser chip 1 became equal to or higher than −20° C.

As illustrated in FIG. 15, components of the backward output light 7 from the semiconductor laser chip 1 traveling toward the monitor PD 8 pass above the short-wavelength transmission filter 30 and are received by the monitor PD 8, irrespective of a change in the environmental temperature, and the relative intensity of the components is monitored.

As described above, according to the semiconductor laser in the fourth embodiment, the quantity of light of the backward output light 7 irradiated onto the light absorber 29 of the mount 28 through the short-wavelength transmission filter 30, whose transmission wavelength characteristic hardly changes with respect to a change in the environmental temperature, automatically increases at the time of low temperature, and the optical absorption by the light absorber 29 of the mount 28 increases. As a result, the temperature of the semiconductor laser chip 1 mounted over the mount 28 rises, thereby enabling to substantially narrow the temperature range on the low temperature side. Accordingly, the characteristics required for signal transmission at the required rate can be satisfied over a wide temperature range. Because the semiconductor laser does not require heating by a heater, there is also no increase in power consumption. Moreover, the semiconductor laser can perform APC without causing a loss in the forward output light 5, by controlling the drive status of the semiconductor laser chip 1 based on the monitoring result obtained by the monitor PD 8.

Next is a description of a fifth embodiment of a semiconductor laser.

FIG. 17 is a sectional view illustrating a configuration of the semiconductor laser of the fifth embodiment.

In FIG. 17, the semiconductor laser of the fifth embodiment, instead of the short-wavelength transmission filter 30 in the configuration of the fourth embodiment illustrated in FIG. 15, is provided with a short-wavelength reflection filter 32, a fixing member 33 that fixes the short-wavelength reflection filter 32, and a post 34 arranged in an upright condition on a stem 3, with the fixing member 33 being fixed to a tip end portion thereof, and the shape of a mount 35 to which a semiconductor laser chip 1 is fixed, and the arrangement of a monitor PD 8 on the stem 3 are changed. The semiconductor laser chip 1, the stem 3, and a post 4 are the same as those of the fourth embodiment.

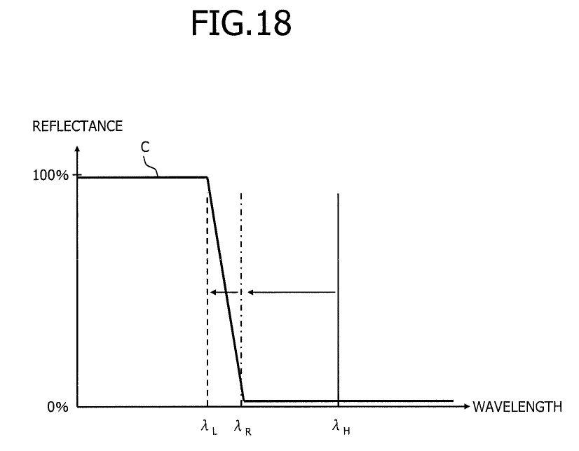

The short-wavelength reflection filter 32 is set up to receive a major part of the backward output light 7 from the semiconductor laser chip 1, reflect light corresponding to the wavelength, and irradiate the reflected light onto a light absorber 36 of the mount 35. The short-wavelength reflection filter 32 is fixed to a distal portion of the post 34 arranged on the stem 3 in an upright condition, via the fixing member 33 formed of a material such as glass which is transparent with respect to the backward output light 7. The short-wavelength reflection filter 32 is formed of a dielectric multilayer film, and has a reflectance-wavelength characteristic C, for example, as illustrated in FIG. 18 (wavelength is plotted on the X axis and transmittance is plotted on the Y axis). Preferably a short-wavelength reflection filter having a wavelength temperature dependence equal to or less than 0.001 nm/° C. is used as the short-wavelength reflection filter 32 as in the short-wavelength transmission filter 30 of the fourth embodiment, and a reflection filter having such a small wavelength temperature dependence is commercially available.

For example, when it is assumed that the oscillation wavelength of the semiconductor laser chip 1 at 85° C. is λ_{H}, the oscillation wavelength thereof at room temperature (25° C.) is λ_{R}, and the oscillation wavelength thereof at −20° C. is λ_{L} (λ_{L}<λ_{R}<λ_{H}), the reflectance-wavelength characteristic C of the short-wavelength reflection filter 32 is designed so that the relation illustrated in FIG. 18 is obtained with respect to the temperature dependence of the oscillation wavelength of the semiconductor laser chip 1, that is, a reflectance close to 100% can be obtained on the short wavelength side from the wavelength λ_{L} and the reflectance approaches 0% on the long wavelength side from near the wavelength λ_{R}. At this time, because the wavelength temperature dependence of the short-wavelength reflection filter 32 is sufficiently smaller than the wavelength temperature dependence of the semiconductor laser chip 1 as mentioned above, it can be ignored.

The mount 35 is formed of a material having a high thermal conductivity such as aluminum nitride (AlN), and includes the light absorber 36 at a position where the backward output light 7 from the semiconductor laser chip 1 is reflected by the short-wavelength reflection filter 32 and the reflected light is irradiated. The light absorber 36 is the same as the light absorber 12 in the first embodiment, and is constituted by applying an infrared absorbing material to the irradiation position on the mount 35 or by bonding a thin plate made of an infrared absorbing material to the irradiation position on the mount 35.

The monitor PD 8 is fixed within a range where a transit area 37 of the backward output light 7 reaches to on the stem 3. The transit area 37 of the backward output light 7 is set in an area in which the backward output light 7 from the semiconductor laser chip 1 travels toward the stem 3, passing through between the short-wavelength reflection filter 32 and the light absorber 36 of the mount 35 without being shielded by the short-wavelength reflection filter 32.

In the semiconductor laser having such a configuration, in the range of the environmental temperature of from 85° C. to room temperature, components of the backward output light 7 from the semiconductor laser chip 1 traveling toward the short-wavelength reflection filter 32 are not reflected by the short-wavelength reflection filter 32, and most parts thereof pass through the short-wavelength reflection filter 32. Because the backward output light 7 having transmitted through the short-wavelength reflection filter 32 passes through the transparent fixing member 33, the backward output light 7 hardly returns to the semiconductor laser chip 1. Therefore, in the high-temperature and room-temperature states, the backward output light 7 is not substantially irradiated onto the light absorber 36 of the mount 35, and the light absorber 31 does not generate heat.

On the other hand, in a range of the environmental temperature of from room temperature to −40° C., the amount of components of the backward output light 7 from the semiconductor laser chip 1 traveling toward the short-wavelength reflection filter 32 and reflected by the short-wavelength transmission filter 32 gradually increases, with a decrease in the temperature from near the room temperature, and the amount of reflection of the backward output light 7 becomes largest near −40° C. Therefore, when the environmental temperature is as low as −40° C., the backward output light 7 is irradiated largely onto the light absorber 36 of the mount 35, and the light absorber 36 generates heat. Therefore, in the low-temperature state, as in the first embodiment, the temperature of the entire mount 35 and the semiconductor laser chip 1 on the mount 35 rises due to heat generation of the light absorber 36. Also in the fifth embodiment, it was confirmed by actual temperature measurement that when the environmental temperature was −40° C., the temperature of the semiconductor laser chip 1 became equal to or higher than −20° C.

As illustrated in FIG. 17, components of the backward output light 7 from the semiconductor laser chip 1 traveling toward the monitor PD 8 pass between the short-wavelength reflection filter 32 and the light absorber 36 of the mount 35 and are received by the monitor PD 8, irrespective of a change in the environmental temperature, and the relative intensity of the components is monitored.

As described above, according to the semiconductor laser of the fifth embodiment, the quantity of light of the backward output light 7 reflected by the short-wavelength reflection filter 32, whose reflection wavelength characteristic hardly changes with respect to a change in the environmental temperature, and irradiated onto the light absorber 36 of the mount 35 automatically increases at the time of low temperature, and the optical absorption by the light absorber 36 of the mount 35 increases to raise its temperature. As a result, the temperature of the semiconductor laser chip 1 mounted over the mount 35 rises, thereby enabling to substantially narrow the temperature range on the low temperature side. Accordingly, the characteristics required for signal transmission at the required rate can be satisfied over a wide temperature range. Because the semiconductor laser does not require heating by a heater, there is also no increase in power consumption. Moreover, the semiconductor laser can perform APC without causing a loss in the forward output light 5, by controlling the drive status of the semiconductor laser chip 1 based on the monitoring result obtained by the monitor PD 8.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical device comprising:
a chip adapted to output laser beams forward and backward;
a mount having the chip mounted thereover;
a light absorber formed on the mount to absorb backward output light from the chip, thereby raising its temperature; and
a light quantity adjuster arranged in an area where the backward output light from the chip propagates, to increase the quantity of light of the backward output light irradiated onto the light absorber, when environmental temperature changes to a low temperature side within an operating temperature range.

2. An optical device according to claim 1, wherein
the light quantity adjuster has a bimetallic shield with an amount of curvature thereof changing according to the temperature,
the bimetallic shield can shield backward output light from the chip, and
the bimetallic shield is arranged so that an amount of the backward output light to be shielded decreases according to deformation of the bimetallic shield when environmental temperature changes to a low temperature side within the operating temperature range.

3. An optical device according to claim 2, comprising:
a monitor arranged in an unshielded area of the backward output light in which the backward output light is not shielded by the bimetallic shield even if environmental temperature changes, to monitor relative intensity of the backward output light, wherein
the mount has a hole in a portion overlapping on the unshielded area, so that the backward output light having passed though the hole can reach the monitor.

4. An optical device according to claim 2, comprising:
a reflecting mirror that reflects backward output light from the chip and irradiates reflected light onto the light absorber, wherein
the bimetallic shield can shield backward output light traveling from the chip to the reflecting mirror.

5. An optical device according to claim 4, comprising:
a monitor arranged in an unshielded area of the backward output light in which the backward output light is not shielded by the bimetallic shield even if environmental temperature changes, to monitor relative intensity of the backward output light having passed through between the reflecting mirror and the light absorber.

6. An optical device according to claim 2, wherein
the bimetallic shield has a structure in which shielded backward output light does not return to the chip.

7. An optical device according to claim 1, wherein
the light quantity adjuster has a shield fixed to a member that extends and contracts according to temperature, and
the shield is arranged so that the shield can shield backward output light from the chip and an amount of the backward output light to be shielded decreases according to displacement of the shield due to contraction or extension of the member when environmental temperature changes to a low temperature side within the operating temperature range.

8. An optical device according to claim 7, comprising:
a monitor arranged in an unshielded area of the backward output light in which the backward output light is not shielded by the shield even if environmental temperature changes, to monitor relative intensity of the backward output light.

9. An optical device according to claim 7, wherein
the shield has a structure in which shielded backward output light does not return to the chip.

10. An optical device according to claim 1, wherein
the light quantity adjuster has a transmission filter having a temperature dependence of the transmittance-wavelength characteristic smaller than a temperature dependence of the oscillation wavelength of the chip,
the transmission filter is arranged so that the backward output light from the chip passes through the transmission filter and is irradiated onto the light absorber, and
the transmittance-wavelength characteristic of the transmission filter is set so that an amount of transmission of the backward output light in the transmission filter increases according to a change in the oscillation wavelength of the chip, when environmental temperature changes to a low temperature side within the operating temperature range.

11. An optical device according to claim 10, wherein
the transmission filter has a temperature dependence of the transmittance-wavelength characteristic, which is equal to or less than 0.001 nm/° C.

12. An optical device according to claim 1, wherein
the light quantity adjuster has a reflection filter having a temperature dependence of the reflection-wavelength characteristic smaller than a temperature dependence of the oscillation wavelength of the chip,
the reflection filter is arranged so that the backward output light from the chip is reflected by the reflection filter and irradiated onto the light absorber, and
the reflection-wavelength characteristic of the reflection filter is set so that an amount of reflection of the backward output light in the reflection filter increases according to a change in the oscillation wavelength of the chip, when environmental temperature changes to a low temperature side within the operating temperature range.

13. An optical device according to claim 12, wherein
the reflection filter has a temperature dependence of the reflection-wavelength characteristic, which is equal to or less than 0.001 nm/° C.
